(19) United States
(12) Patent Application Publication
(10) Pub. No.: US 2015/0216003 A1
(43) Pub. Date: Jul. 30, 2015

(54) Anti-Flickering LED Lighting System

(71) Applicant: Acorntech Limited, Saratoga, CA (US)

(72) Inventors: Chungjen Chien, Saratoga, CA (US); Kenneth Y. Mok, Sunnyvale, CA (US); Minh Quang Tran, San Jose, CA (US)

(73) Assignee: Acorntech Limited, Saratoga, CA (US)

(21) Appl. No.: 14/259,084

(22) Filed: Apr. 22, 2014

Related U.S. Application Data
(63) Continuation-in-part of application No. 14/164,105, filed on Jan. 24, 2014.

(51) Int. Cl. H05B 33/08

(52) U.S. Cl. CPC H05B 33/0809; H05B 33/0845

(57) ABSTRACT

An LED lighting system has anti-flickering capabilities. The LED lighting system comprises: a rectifier, wherein the rectifier generates a rectified input voltage; a lighting block; and an energy storage device (“ESD”) for generating a first voltage, wherein if the rectified voltage is less than a predefined threshold voltage, the generated first voltage is applied to the lighting block, else, the rectified input voltage is applied to the lighting block and to the ESD.

### CROSS REFERENCE

This application claims priority to and is a continuation-in-part of the nonprovisional patent application entitled “An LED Lighting System” filed on Jan. 24, 2014 and having an application Ser. No. 14/164,105. Said application is incorporated herein by reference.

### FIELD OF INVENTION

This disclosure generally relates to a light emitting diode (“LED”) lighting system, and, in particular, to an anti-flickering LED lighting system.

### BACKGROUND

Light emitting diodes lighting systems, e.g., LED lamps, LED bulbs, and other LED lighting systems, are commonly powered by direct current (“DC”) voltages. Since many households and commercial establishments use alternating current (“AC”) voltages for providing power, LED lighting systems require converters for switching the AC power supply to an acceptable DC voltage for the LED lighting systems.

For instance, a rectifier can be used to convert the AC voltage to a DC variable voltage, i.e., a rectified voltage of the AC voltage. However, due to the sinusoidal characteristic of the AC voltage, the rectified voltage will have peaks and valleys. Subsequently, the rectified voltage may not be high enough to keep the LEDs of the lighting system turned on since the rectified voltage may drop below the turn on voltage of the LEDs. Another problem is that the rectified voltage may cause a flickering effect from the LEDs of the lighting system since the LEDs' brightness depends on the current used to drive the LEDs. The flickering effect is uncomfortable to human eyes and is not suitable for various lighting applications. Thus, the flickering effect should be reduced or altogether eliminated. Therefore, there exists a need for providing an LED lighting system that can reduce or eliminate flickering effects.

### SUMMARY OF INVENTION

Briefly, the disclosure relates to an LED lighting system, comprising: a rectifier, wherein the rectifier generates a rectified input voltage; a lighting block; and an energy storage device (“ESD”) for generating a first voltage, wherein if the rectified voltage is less than a predefined threshold voltage, the generated first voltage is applied to the lighting block, else, the rectified input voltage is applied to the lighting block and to the ESD.

### DESCRIPTION OF THE DRAWINGS

The foregoing and other objects, aspects, and advantages of the disclosure can be better understood from the following detailed description of the embodiments when taken in conjunction with the accompanying drawings.

FIG. 1 illustrates a diagram of an anti-flickering lighting system.

FIG. 2 illustrates a diagram of an energy storage device.

FIG. 3 illustrates a diagram of a lighting block.

FIG. 4 illustrates another diagram of a lighting block.

FIG. 5a illustrates a graph having various data from an LED lighting system plotted side-by-side along a time axis.

FIG. 5b illustrates a graph for an applied voltage of an LED lighting system.

FIG. 5c illustrates a graph for a brightness level of an LED lighting system.

FIGS. 6a-6b illustrate graphs of multiphase rectified voltages.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

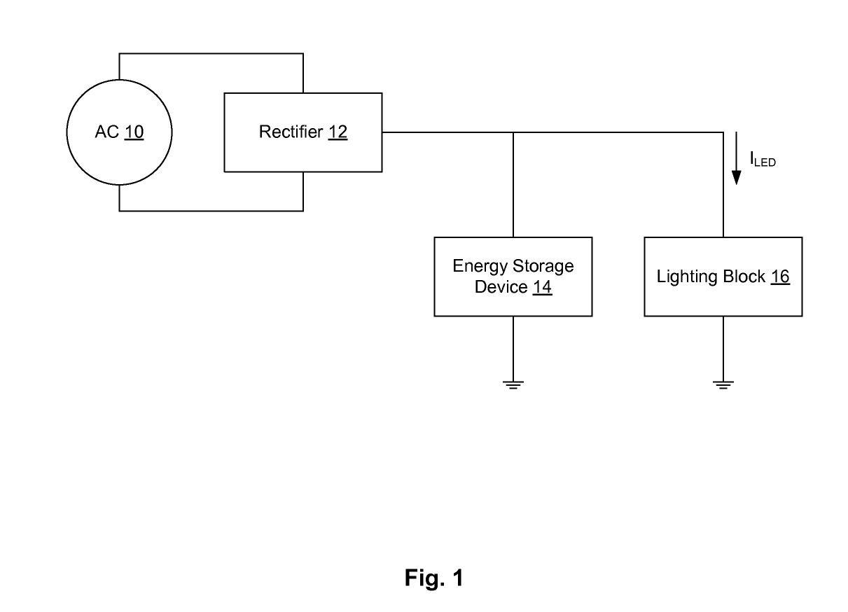

FIG. 1 illustrates a diagram of an anti-flickering lighting system. An anti-flickering lighting system can comprise an alternating current (“AC”) voltage source 10, a rectifier 12, an energy storage device 14, and a lighting block 16. The AC voltage source 10 supplies an AC voltage, which can be rectified by the rectifier 12.

The rectified voltage is applied to the energy storage device 14 and the lighting block 16. If the rectified voltage is below a predefined threshold voltage, the ESD 14 can be in a discharge mode that applies an ESD generated voltage on the lighting block 16. During the discharge mode, the voltage applied by the ESD 14 drives the current I_{LED} to the lighting block 16. The lighting block 16 can also have a current regulator for regulating the current I_{LED} to a predefined value.

If the rectified voltage is at or above the predefined threshold voltage, the ESD 14 can be in a charging mode. During this condition, the rectified voltage is applied to the lighting block 16 and the ESD 14. The rectifier 12 can be used to charge the ESD 14. The ESD 14 can be a battery, one or more capacitors, inductor, and/or in conjunction with other circuit elements for storing energy. The rectified voltage from the rectifier 12 can drive the current I_{LED}. The lighting block 16 can also have a current regulator for regulating the current I_{LED} to a predefined value.

As the rectified voltage changes from a peak voltage to a low voltage, an applied voltage on the lighting block 16 can be provided in alternating fashion by the rectifier 12 and the ESD 14. Thus, the lighting block 16 can be provided an ample voltage for driving the LEDs of the lighting block 16.

To aid in the understanding of the disclosure, a single lighting block is illustrated. However, is it understood by a person having ordinary skill in the art that an array of lighting blocks can be connected in together in accordance with the disclosure, where each of the lighting blocks can have a single LED or multiple LEDs. Therefore, other variations of lighting blocks and other equivalent systems are included in the scope of the disclosure.

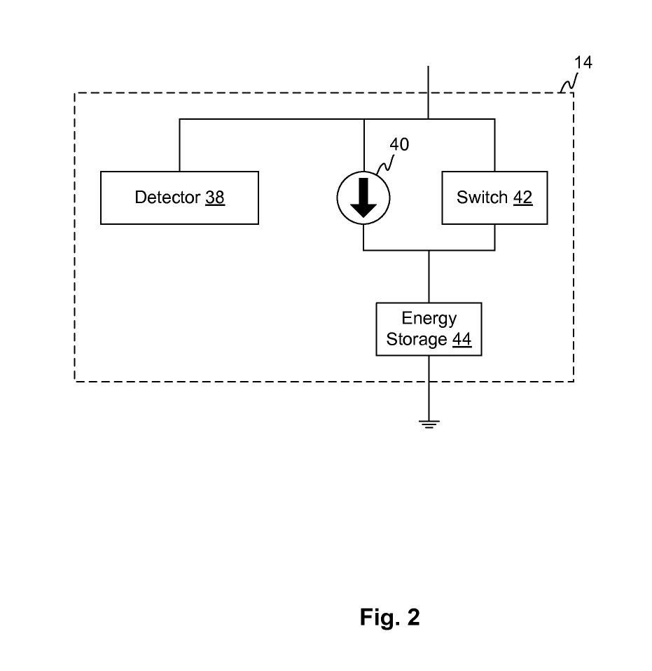

FIG. 2 illustrates a diagram of an energy storage device. The energy storage device 14 can be implemented by various circuit elements for storing energy, where the energy storage device 14 can have two operational modes, a charging mode and a discharging mode. In an example, the energy storage device 14 can comprise a voltage detector 38, a current source 40, a switch 42, and an energy storage device 44. The voltage detector 38 can determine when the rectified voltage of the lighting system is below the predefined threshold voltage. When the rectified voltage is below the predefined threshold voltage, the ESD 14 is in the discharging mode. Otherwise, the ESD 14 is placed in the charging mode.

When the ESD 14 is in the discharging mode, the current source 40 is deactivated and the switch 42 is closed, i.e., on or activated, allowing a direct connection between the lighting block 16 and the energy storage 44. The energy storage 44 has a voltage potential that is applied on the lighting block 16 via the switch 42 for driving the LEDs of the lighting block 16.

When the ESD 14 is in the charging mode, the current source 40 is activated and the switch 42 is opened. The rectified voltage is then applied on the current source 40 to charge the energy storage device 44. The electrical path through the switch 42 is not possible since the switch 42 is opened, i.e., off or deactivated.

In other embodiments, the current source 40 can comprise one or more current sources, the switch 42 can comprise one or more switches, and/or the energy storage device 44 can comprise one or more capacitors. It is understood that other specific circuit configurations can be used by a person having ordinary skill in the art based on the disclosure.

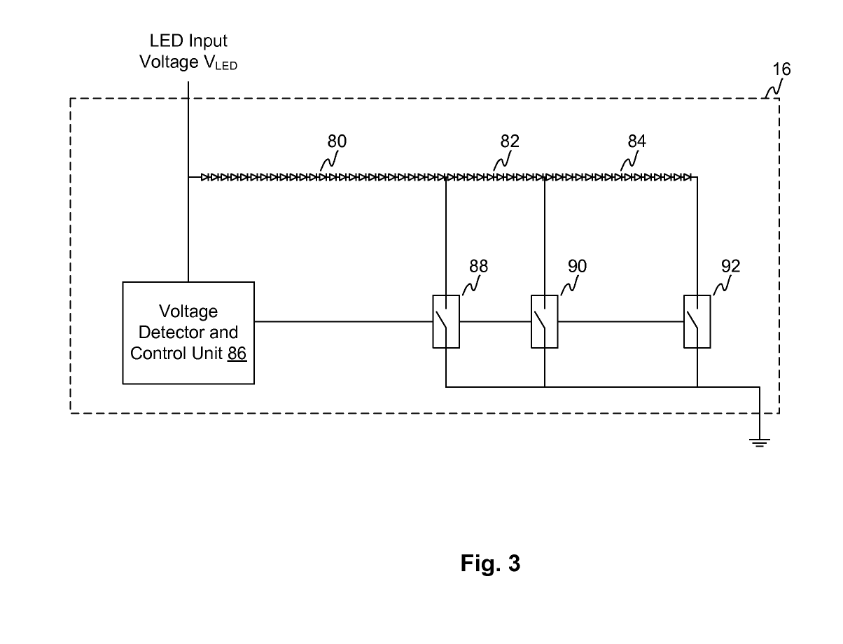

FIG. 3 illustrates a diagram of a lighting block. In an example of the lighting block 16, the lighting block 16 can comprise segments 80-84 of LEDs, a voltage detector and control unit 86, and constant current switches 88-92. The segment 80 comprises 25 LEDs; the segment 82 comprises 10 LEDs; and segment 84 comprises 15 LEDs. The voltage drop across each of the LEDs in the segments 80-84 can be around the same value, given ideal performance. To aid in the understanding of the disclosure, the following example illustrates three segments of LEDs having different number of LEDs in each of the segments. However, it is understood that the number of segments, the number of LEDs in each segment, and/or the voltage drop across each of the LEDs in the segments can be adjusted as desired in accordance with the disclosure. The following example is not meant to limit the disclosure in any manner, e.g., to any number of LEDs and/to any number of segments.

The voltage detector and control unit 86 can detect the LED input voltage V_{LED}, and activate various segments of the LEDs or deactivate various segments of the LEDs depending on the LED input voltage V_{LED}. The voltage detector and control unit 86 (or other control logic) can turn on or off the current switches 88-92 as needed for activating or deactivating the segments 80-84. For instance, when the LED input voltage V_{LED} is below a first predefined voltage V₁, then the segment 80, i.e., the first 25 LEDs of the lighting block 16, is activated and the segments 82 and 84 are deactivated. To activate segment 80 only, the switch 88 is on and the switches 90-92 are off. When the switch 88 is on, the LEDs of the segment 80 are electrically connected to ground via the switch 88. Since the switches 90 and 92 are off, the segments 82 and 84 are effectively deactivated regardless of the LED input voltage since their electrical path to ground is blocked via the switches 90 and 92.

When the LED input voltage V_{LED} is greater than or equal to the first predefined voltage V₁ and less than or equal to a second predefined voltage V₂, then the segments 80 and 82, i.e., the first 35 LEDs of the lighting block 16, are activated, and the segment 84 is deactivated. To activate segments 80 and 82 only, the switch 90 is on and the switches 88 and 92 are off. When the switch 90 is on and the switches 88 and 92 are off, the LEDs of the segments 80 and 82 are electrically connected to ground via the switch 90. The segment 84 is effectively deactivated regardless of the LED input voltage since the segment 84's electrical path to ground is blocked via the switch 92. Furthermore, since the switch 88 is off, the current through the LEDs of the segment 80 cannot run through the switch 88 to ground, but rather run serially through the electrical path to the LEDs of the segment 82, and ultimately to ground via the switch 90.

When the LED input voltage V_{LED} is greater than the second predefined voltage V₂, then the segments 80, 82, and 84, i.e., all 50 LEDs of the lighting block 16, are activated. To activate the segments 80-84, the switch 92 is on and the switches 88 and 90 are off. In this configuration, the LEDs of the segments 80-84 are electrically connected to ground via the switch 92. Since the switches 88 and 90 are off, current cannot run through switches 88 and 90 to ground. Instead, the electrical current runs through to the segment 80, next to the segment 82, then to the segment 84, and ultimately to ground via the switch 92.

Table 1 below summarizes these conditions for reference.

TABLE 1

| | V_{LED} < V₁ | V₁ ≦ V_{LED} ≦ V₂ | V2 < V_{LED} |
|---|---|---|---|
| Switch 88 | On | Off | Off |
| Switch 90 | Off | On | Off |
| Switch 92 | Off | Off | On |

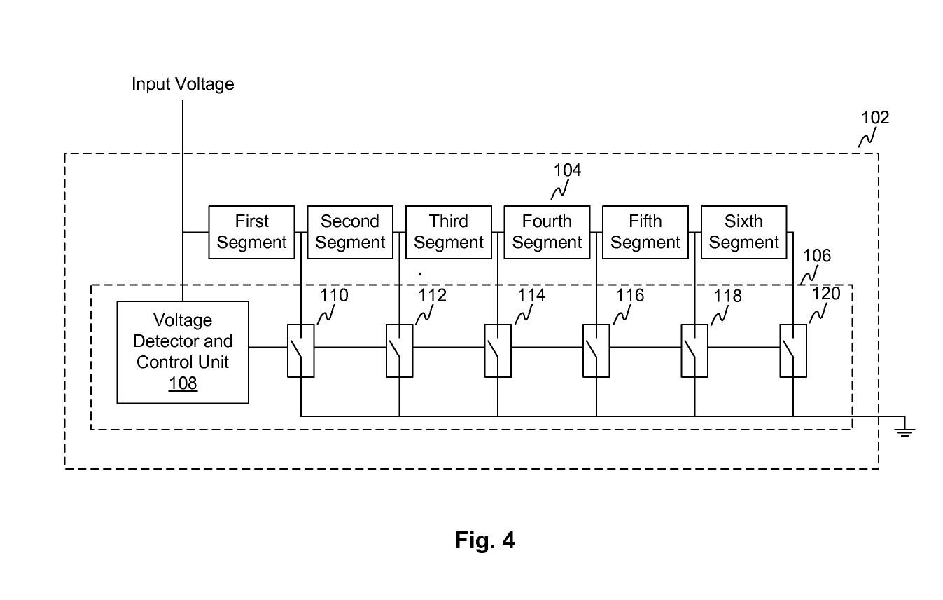

FIG. 4 illustrates another diagram of a lighting block. A lighting block 102 can comprise serially-connected segments of LED arrays 104, a voltage detector and control unit 108, and constant current switches 110-120.

The LED arrays 104 are illustrated by a first segment, a second segment, a third segment, a fourth segment, a fifth segment, and a sixth segment, where each of the segments can comprise an LED array of LEDs connected in series and/or in parallel, or can alternatively be a single LED. It is understood by a person having ordinary skill in the art that the LED arrays 104 can be arranged in other configurations, including in parallel, or in combination of parallel and serial. The present illustration is not meant to limit the disclosure since other configurations are apparent to a person having ordinary skill in the art based on the disclosure.

One or more segments of the LED arrays 104 are activated as a function of the input voltage. The voltage detector and control unit 108 detects the input voltage, and turns on a number of segments of the LED arrays 104 that can be driven by the input voltage. For instance, if each segment of the LED arrays 104 can handle a 20V voltage drop to drive the respective segment and the input voltage is 60V, then the first three segments of the LED arrays 104 can be activated and the last three segments of the LED arrays 104 can be deactivated via the current switches 110-120. It is understood that each segment of the LED arrays 104 can have different number of LEDs and different voltage drops across each one of the LEDs of the LED arrays.

Since the input voltage can be a rectified voltage or an ESD generated voltage, the segments of the LED arrays 104 can be automatically activated or deactivated to correspond to the varying input voltage. Each segment of the LED arrays 104 can be turned on sequentially as the input voltage increases to preset values to drive the LED arrays 104 of the activated segments. Likewise, as the input voltage decreases, the segments of the LED arrays 104 can be sequentially turned off. The preset values can depend on the amount of voltage drop across each of the segments. For each segment of the LED arrays 104 that is turned on, the input voltage should be high enough to drive that segment's LEDs and any previous segment's LEDs.

In other embodiments of the disclosure, the segments of the LED arrays 104 can be turned on in a preselected order, rather than sequentially. For instance, additional switching mechanisms can be used to maintain that one or more certain segments of the LED arrays 104 are on, and/or the segments of the LED arrays 104 can be activated (i.e., turned on) or deactivated (i.e., turned off) according to the preselected order.

The input voltage is connected to a first end of the serially-connected segments of the LED arrays 104. The voltage detector and control unit 108 can detect the input voltage and select which one of the constant current switches 110-120 to turn on. As the input voltage rises from its lowest value (e.g., around the ESD generated voltage) to its peak value (e.g., around 170V for a 120V AC voltage source), the constant current switches 110-120 can be sequentially turned on to match this rise in voltage. When a certain one of the constant current switches 110-120 is activated, the other ones of the constant current switches are deactivated such that the certain one of the constant current switches provides an electrical path to ground. Each one of the constant current switches 110-120 that are turned on can provide a current pass to the ground. Thereby, the serially-connected segments of the LEDs 104 are sequentially turned on to match the increasing input voltage.

Additionally, the constant current switches 110-120 can also be sequentially turned on in a reverse order when the input voltage lowers from the peak voltage to its lowest voltage. Similarly, when a certain one of the constant current switches 110-120 is activated in the reverse order to match the decreasing input voltage, the other ones of the constant current switches are deactivated such that the certain one of the constant current switches provides an electrical path to ground. Each of the constant current switches 110-120 that are turned off block the respective current pass to the ground. Thereby, the serially-connected segments of the LEDs 104 are sequentially turned off to match the decreasing input voltage.

The LED arrays 104 can be grouped into six segments of LED arrays for this example. However, any number of segments or individual LEDs and/or LED arrays can be used in accordance with the disclosure. Furthermore, each segment may have a differing number of LEDs, depending on the total amount of voltage drop designed for the respective segment.

When the constant current switch 110 is activated and the constant current switches 112-120 are deactivated, a first predefined amount of current is drawn through a first segment of the LED arrays 104 to ground. When the constant current switch 110 is deactivated, an electrical current can run through the first segment to one or more of the remaining segments of the LED arrays 104, depending on which one of the constant current switches 112-120 is activated.

When the constant switch 112 is activated and the constant current switches 110 and 114-120 are deactivated, a second predefined amount of current (e.g., around 100 mA) is drawn through the first segment of the LED arrays 104, a second segment of the LED arrays 104, and then to ground. When the constant current switches 110 and 112 are deactivated, an electrical current can be routed through the first segment and second segment of the LED arrays 104 to one or more remaining segments of the LED arrays 104, depending on which one of the constant current switches 114-120 is activated.

When the constant switch 114 is activated and the constant current switches 110, 112, 116-120 are deactivated, a third predefined amount of current is drawn through the first segment, the second segment, a third segment of the LED arrays 104, and then to ground. When the constant current switches 110, 112, and 114 are deactivated, an electrical current can be routed through the first segment, second segment, and third segment of the LED arrays 104 to one or more remaining segments of the LED arrays 104, depending on which one of the constant current switches 116-120 is activated.

When the constant switch 116 is activated and the constant current switches 110-114 and 118, and 120 are deactivated, a fourth predefined amount of current is drawn through the first segment, the second segment, the third segment, and a fourth segment of the LED arrays 104, and then to ground. When the constant current switches 110, 112, 114, and 116 are deactivated, an electrical current can be routed through the first segment, the second segment, the third segment, and the fourth segment of the LED arrays 104 to one or more of the remaining segments of the LED arrays 104, depending on which one of the constant current switches 118 and 120 is activated.

When the constant switch 118 is activated and the constant current switches 110-116 and 120 are deactivated, a fifth predefined amount of current is drawn through the first segment, the second segment, the third segment, the fourth segment, and a fifth segment of the LED arrays 104, and then to ground. When the constant current switches 110-118 are deactivated, an electrical current can be routed through the first segment, the second segment, the third segment, the fourth segment, and the fifth segment of the LED arrays 104 to a sixth segment of the LED arrays 104, depending on whether the constant current switch 120 is activated.

When the constant switch 120 is activated and the constant current switches 110-118 are deactivated, a sixth predefined amount of current is drawn through the first segment, the second segment, the third segment, the fourth segment, the fifth segment, and the sixth segment of the LED arrays 104, and then to ground. The first predefined amount of current, the second predefined amount of current, the third predefined amount of current, the fourth predefined amount of current, the fifth predefined amount of current, and the sixth predefined amount of current are different such that the overall brightness of the lighting block 102 remains constant even though a different number of LEDs are activated at various times. This can greatly reduce flickering or any spectroscopic errors.

At the minimum, a lighting block can be a single LED that is connected to the input voltage and ground. Alternatively, each segment of a lighting block can comprise one or more LEDs, connected in series and/or in parallel.

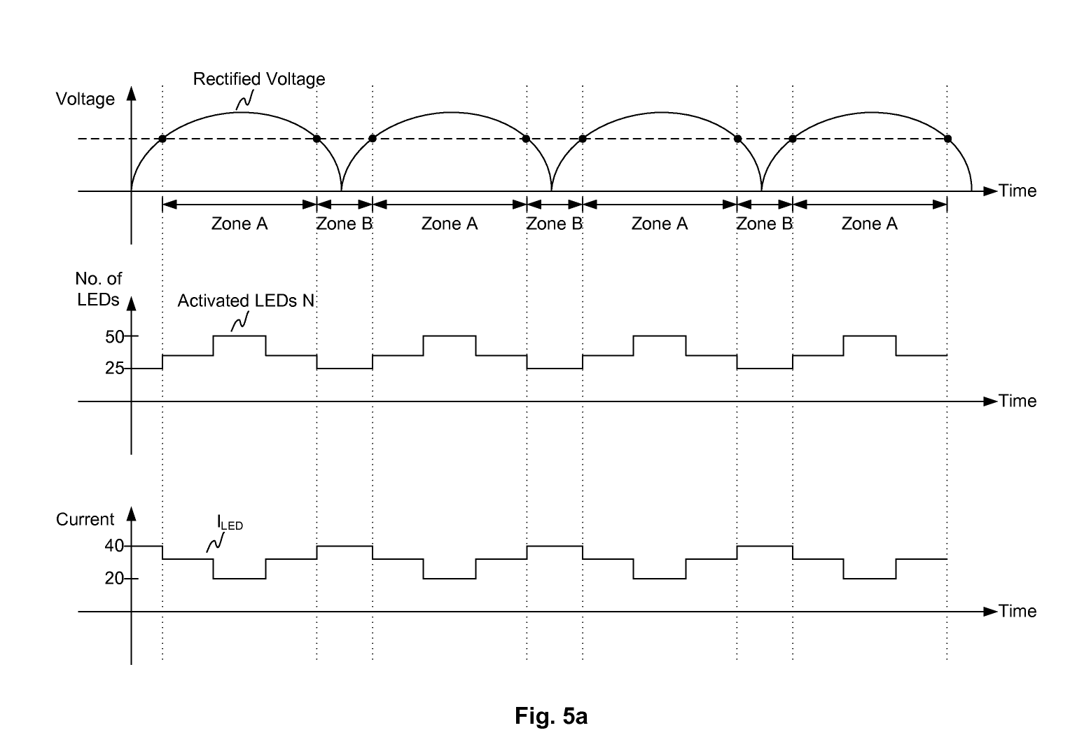

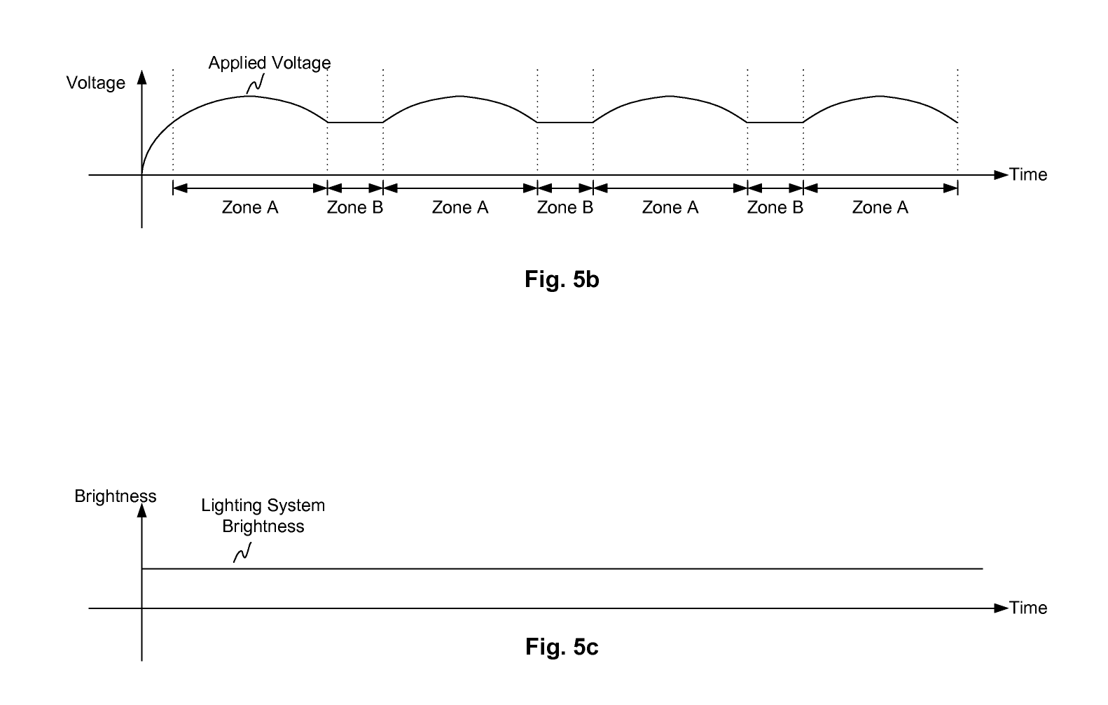

FIG. 5a illustrates a graph having various data from an LED lighting system plotted side-by-side along a time axis. An LED lighting system can maintain a predefined brightness level even with a varying number of activated LEDs, N, at a given time by varying an LED current I_{LED} through the activated LEDs. Brightness can be quantified by the following equation:

I_{LED}*N=Brightness. Equation [1]

According to Equation [1], the LED current I_{LED} can be varied to maintain the same brightness level when the number of activated LEDs N is varied.

For instance, the LED lighting system in FIG. 3 illustrates three segments of LEDs that can be separately or collectively activated. In a first scenario, the first 25 LEDs (i.e., the first segment) are activated. In a second scenario, the first 35 LEDs (i.e., the first and second segments) are activated. In a third scenario, all 50 LEDs (i.e., the first, second, and third segments) are activated. In order to keep the overall brightness level around a constant level when the number of activated LEDs changes, the current through the activated LEDs I_{LED} can also be changed according to Equation [1].

Referring to FIG. 5a, a rectified voltage can be applied to the lighting block 16 (illustrated in FIG. 3). A graph of a rectified voltage, a number of activated LEDs, and an LED current I_{LED} are plotted along a time axis. The rectified voltage is plotted on a graph having time for the horizontal axis and voltage for the vertical axis. The rectified voltage can have two zones delineated by a predefined threshold voltage. When the rectified voltage is greater than or equal to the predefined threshold voltage, this time range can be referred to as zone A. When the rectified voltage is less than the predefined threshold voltage, this time range can be referred to as zone B. Since the rectified voltage is cyclic, zone A and zone B alternate between each other according to the AC input voltage to the lighting system.

During zone A, the rectified voltage is high enough to charge the ESD and to drive the activated LEDs of the lighting system. During zone B, the respective energy storage device of the lighting system discharges its electrical energy to drive the activated LEDs of the lighting system to reduce flickering.

Additionally, the number of activated LEDs can vary during zone A and zone B. During zone A, when the rectified voltage exceeds a second threshold voltage, the activated LEDs can increase from 35 LEDs to 50 LEDs. Also, the activated LEDs can decrease from 50 LEDs to 35 LEDs when the rectified voltage drops from above the second predefined voltage to below the second predefined voltage. During zone B, the activated LEDs can be set to a lower number, e.g., 25 LEDs.

Since the activated LEDs are varied from 25 LEDs, to 35 LEDs, then to 50 LEDs, and back down, the LED current I_{LED} also changes to match the changing number of activated LEDs according to Equation [1], such that the overall brightness remains around a constant level. Assuming the brightness of the respective lighting system is 1000 lumens, the current can be set to I_{LED}=40 mA when 25 LEDs are activated, to I_{LED}=28.57 mA when 35 LEDs are activated, or to I_{LED}=20 mA when 50 LEDs are activated.

FIG. 5b illustrates a graph for an applied voltage of an LED lighting system. The applied voltage on the activated LEDs can comprise the rectified voltage in zone A and the ESD voltage in zone B.

FIG. 5c illustrates a graph for a brightness level of an LED lighting system. Since the current can be set to I_{LED}=40 mA when 25 LEDs are activated, to I_{LED}=28.57 mA when 35 LEDs are activated, or to I_{LED}=20 mA when 50 LEDs are activated, the relative overall brightness of the LED lighting system can remain relatively constant.

As understood by a person having ordinary skill in the art, the various conditions and numerical values of this example can be altered in accordance with the disclosure. Thus, this example is not meant to limit the disclosure.

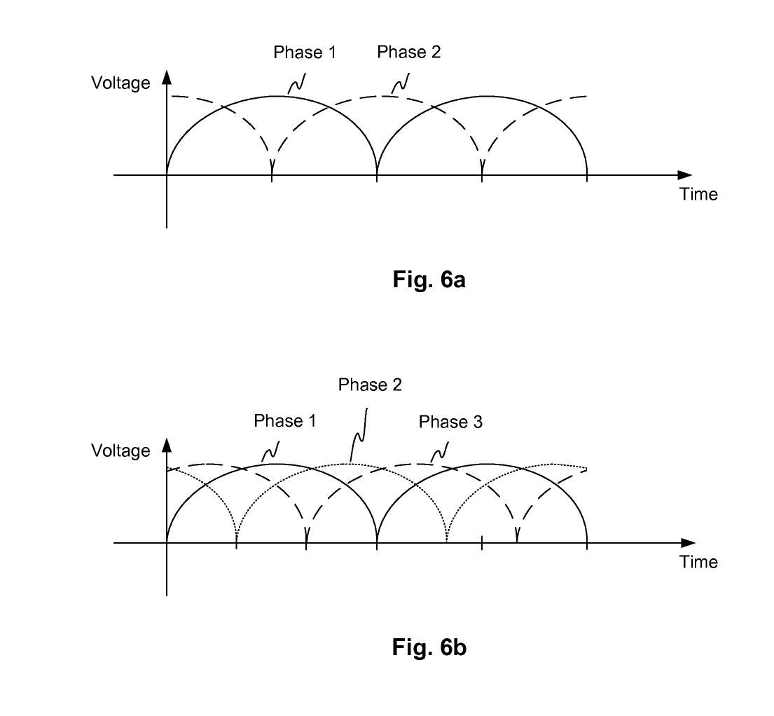

FIG. 6a-6b illustrates a graph of multiphase rectified voltages. The input voltage to a lighting system can have multiple phases. For such multi-phase input voltage, the zone A and zone B can be defined for this input voltage as well.

FIG. 6a illustrates a graph of a two-phase input voltage. The input voltage can have two phases as illustrated by phase 1 and phase 2 to be applied to the LED lighting system, where phase 1 and phase 2 have a phase difference of 90 degrees. The peak (i.e., a high voltage value) of phase 1 occurs at the valley (i.e., a low voltage value) of phase 2, and vice versa. The phase difference can also range anywhere from greater than 0 degrees to less than or equal to 90 degrees. A first predefined threshold voltage and the second predefined threshold voltage can be defined for this multiphase input voltage for the purpose of the disclosure for use in determining the number of activated LEDs and the LED current.

FIG. 6b illustrates a graph of a three-phase input voltage. In this example, a three phase input voltage can be used to drive the LED lighting system, where the phase difference between phase 1 and phase 2 is 60 degrees and the phase difference between phase 2 and phase 3 is 60 degrees. In other examples, the phase difference between phase 1 and phase 2 can be within the range of 0<θ<60. Also, the phase difference between phase 2 and phase 3 can be within the range of 0<θ<60. Furthermore, a multiple number of phases can be used to keep the overall input voltage applied on the LED lighting system at or about a certain voltage level. A first predefined threshold voltage and the second predefined threshold voltage can be defined for this multiphase input voltage as well for the purpose of the disclosure for use in determining the number of activated LEDs and the LED current.

While the disclosure has been described with reference to certain embodiments, methods, apparatuses, and/or systems, it is to be understood that the disclosure is not limited to such specific embodiments, methods, apparatuses, and/or systems. Rather, it is the inventor's contention that the disclosure be understood and construed in its broadest meaning as reflected by the following claims. Thus, these claims are to be understood as incorporating not only the apparatuses, methods, and systems described herein, but all those other and further alterations and modifications as would be apparent to those of ordinary skilled in the art.

We claim:

1. An LED lighting system, comprising:
a rectifier, wherein the rectifier generates a rectified input voltage;
a lighting block; and
an energy storage device (“ESD”) for generating a first voltage,
wherein if the rectified voltage is less than a predefined threshold voltage,
the generated first voltage is applied to the lighting block, else,
the rectified input voltage is applied to the lighting block and to the ESD.

2. The LED lighting system of claim 1 wherein when the rectified input voltage is equal to or above the predefined voltage, the ESD is in a charge mode and the rectified input voltage is applied to lighting block and to the ESD.

3. The LED lighting system of claim 1 wherein when the rectified voltage is below the predefined threshold voltage, the ESD is in a discharge mode and an ESD voltage is applied to the lighting block.

4. The LED lighting system of claim 1 wherein the lighting block comprises a plurality of light-emitting diodes (“LEDs”), and wherein certain ones of the LEDs are activated as a function of the applied voltage on the lighting block.

5. The LED lighting system of claim 4 wherein the lighting block further comprises one or more constant current sources, wherein a certain one of the constant current sources maintains an LED current through the activated LEDs at a predefined level.

6. The LED lighting system of claim 5 wherein the predefined level is set as a function of the number of activated LEDs and a predefined brightness level.

7. The LED lighting system of claim 5 wherein the predefined level is set as a function of the rectified input voltage.

8. The LED lighting system of claim 5 wherein the predefined level is adjusted as the number of activated LEDs varies.

9. The LED lighting system of claim 5 wherein the predefined level is adjusted as the rectified input voltage varies.

10. The LED lighting system of claim 1 wherein the rectifier outputs the rectified voltage to the ESD and the lighting block via an electrical path, wherein the ESD comprises a voltage detector, a current source, one or more capacitors, and a switch, wherein the voltage detector detects the rectified voltage, and wherein the ESD determines whether the rectified voltage is below the predefined threshold voltage.

11. The LED lighting system of claim 10 wherein the current source and the switch of the ESD are connected in parallel across the electrical path and a first end of the capacitors, and wherein the voltage detector operates the current source and the switch as a function of the rectified voltage.

12. The LED lighting system of claim 11 wherein when the rectified voltage is below the predefined threshold voltage, the switch is closed and the generated ESD voltage is applied to the electrical path to drive the lighting block.

13. The LED lighting system of claim 11 wherein when the rectified voltage is at or above the predefined threshold voltage, the switch is opened and the capacitors are charged via the current source.

14. The LED lighting system of claim 1 wherein the rectifier outputs the rectified voltage to the ESD and the lighting block via an electrical path, wherein the ESD comprises a voltage detector, one or more current sources, one or more capacitors, and one or more switches, wherein the voltage detector detects the rectified voltage, and wherein the ESD determines whether the rectified voltage is below the predefined threshold voltage.

15. An LED lighting system, comprising:
a rectifier, wherein the rectifier generates a rectified input voltage; and
a lighting block having a plurality of light-emitting diodes (“LEDs”) and one or more constant current sources,
wherein certain ones of the LEDs are activated as a function of the rectified input voltage on the lighting block, and
wherein a certain one of the constant current sources maintains an LED current through the activated LEDs at a predefined level.

16. The LED lighting system of claim 15 wherein the predefined level is set as a function of the number of activated LEDs and a predefined brightness level.

17. The LED lighting system of claim 15 wherein the predefined level is set as a function of the rectified input voltage.

18. The LED lighting system of claim 15 wherein the predefined level is adjusted as the number of activated LEDs varies.

19. The LED lighting system of claim 15 wherein the predefined level is adjusted as the rectified input voltage varies.

20. An LED lighting system, comprising:
a rectifier, wherein the rectifier generates a rectified input voltage;
a lighting block having a plurality of light-emitting diodes (“LEDs”) and one or more constant current sources; and
an energy storage device (“ESD”) for generating a first voltage,
wherein if the rectified voltage is less than a predefined threshold voltage,
the generated first voltage is applied to the lighting block, else,
the rectified input voltage is applied to the lighting block and to the ESD,
wherein certain ones of the LEDs are activated as a function of the applied voltage on the lighting block,
wherein a certain one of the constant current sources maintains an LED current through the activated LEDs at a predefined level,
wherein when the rectified input voltage is equal to or above the predefined voltage, the ESD is in a charge mode and the rectified input voltage is applied to lighting block and to the ESD,
wherein when the rectified voltage is below the predefined threshold voltage, the ESD is in a discharge mode and an ESD voltage is applied to the lighting block,
wherein the predefined level is set as a function of one or more of the following: the number of activated LEDs, a predefined brightness level, and the rectified input voltage,
wherein the predefined level is adjusted as the number of activated LEDs varies,
wherein the predefined level is adjusted as the rectified input voltage varies,
wherein the rectifier outputs the rectified voltage to the ESD and the lighting block via an electrical path,
wherein the ESD comprises a voltage detector, a current source, one or more capacitors, and a switch, wherein the voltage detector detects the rectified voltage,
wherein the ESD determines whether the rectified voltage is below the predefined threshold voltage,
wherein the current source and the switch of the ESD are connected in parallel across the electrical path and a first end of the capacitors,
wherein the voltage detector operates the current source and the switch as a function of the rectified voltage,
wherein when the rectified voltage is below the predefined threshold voltage, the switch is closed and the generated ESD voltage is applied to the electrical path to drive the lighting block, and
wherein when the rectified voltage is at or above the predefined threshold voltage, the switch is opened and the capacitors are charged via the current source.
